(19) United States
(12) Patent Application Publication
(10) Pub. No.: US 2026/0004277 A1
(43) Pub. Date: Jan. 1, 2026

(54) SYSTEM, DEVICE AND METHOD FOR DIGITAL PAYMENT

(71) Applicant: NAYAX LTD., Herzliya (IL)

(72) Inventors: David BEN-AVI, Herzliya (IL); Guy ROSENHOIZ, Herzliya (IL)

(21) Appl. No.: 18/880,650

(22) PCT Filed: Aug. 9, 2023
(86) PCT No.: PCT/IL2023/050832

§ 371 Date: Jan. 2, 2025

(30) Foreign Application Priority Data
Sep. 1, 2022 (IL) 296175

(51) Int. Cl. G06Q 20/36; G06Q 20/20; G06Q 20/32; G06Q 20/34; G06Q 20/38; G06Q 20/40

(52) U.S. Cl. CPC G06Q 20/36; G06Q 20/20; G06Q 20/3224; G06Q 20/3278; G06Q 20/348; G06Q 20/382; G06Q 20/4016

(57) ABSTRACT

A system, and a product for purchasing goods with a digital wallet application is disclosed. The system includes an issuer server comprising processing circuitry. The processing circuitry is configured to: issue a single-use payment card string based on a location of a computing device comprising a digital wallet application. The digital wallet application is configured to enable payment by transferring the payment string to a payment terminal at a point of sale (POS) of a merchant and the payment terminal is configured to request approval for a requested amount of money from the issuer server and to receive the requested amount of money after the approval from the issuer server.

### CROSS REFERENCE TO RELATED APPLICATIONS

This application is a National Phase of PCT Patent Application No. PCT/IL2023/050832 having International filing date of Aug. 9, 2023, which claims the benefit of priority of Israeli Patent Application No. 296175, filed Sep. 1, 2022, the contents of which are all incorporated herein by reference in their entirety.

### TECHNICAL FIELD

Some embodiments described herein generally relayed to a digital payment method and system, more specifically, for issuing a payment string.

### BACKGROUND

A digital payment system may use a digital wallet to perform payments over the Internet and/or local networks and/or stores. The digital wallet may have and/or include one or more credit card information and/or the bank account information and/or any other payment method and/or balance of a buyer. The credit card may be issued by the local bank or the local credit card issuer and may be used internationally. The digital wallet has access to such buyer's payment account and/or accounts to purchase merchandise on the Internet or at physical stores.

### SUMMARY

Embodiments related to a system, a method, and a product for issuing a single-use payment card string are described hereinbelow by the ways of example only.

One embodiment may include a system for making payments with a digital wallet application. The system comprising: a computing device and an issuer server comprises processing circuitry, wherein the processing circuitry is configured to: receive a location of the computing device from a location unit in the computing device and determine a number of a payment string based on the location; issue a single-use payment card string based on the location of the computing device; upload the single-use payment card string to a digital wallet application installed on the computing device, wherein the digital wallet application is configured to enable payment by transferring the payment string to a payment terminal at a point of sale (POS) of a merchant and the payment terminal is configured to request approval for a requested amount of money from the issuer server and to receive the requested amount of money after the approval from the issuer server; sending a request to remove the single-use payment card string from the digital wallet when a payment session ends; and delete the single-use payment card string.

For example, the location unit receiver comprises an at least one of Global Positioning System (GPS) receiver, Galileo receiver, Glonass receiver, BeiDou receiver, Quasi-Zenith Satellite System receiver (QZSS) and Indian Regional Navigation Satellite System (IRNSS) receiver.

For example, the issuer server is configured to receive the longitude and latitude of the mobile device and determine a number of the payment string based on the location.

For example, the issuer server is configured to receive the longitude and latitude of the mobile device and determine a number of the payment string based on the location.

For example, the payment string comprises a payment card number according to a Europay, Mastercard, Visa (EMV) standard based on the location.

For example, the single-use payment card string is downloaded with the requested amount of money for paying at the POS.

For example, the single-use payment card string comprises a credit card number, a credit card date of issue, and a credit card security code.

For example, the single-use payment card string comprises a zero amount of money and user data.

For example, the processing circuitry is configured to transfer the payment card string to the payment terminal by using a near field communication (NFC).

Another embodiment may include a product comprising one or more tangible computer-readable non-transitory storage media comprising program instructions for making payments with a digital wallet application, wherein execution of the program instructions by one or more processors of an issuer server comprising: receiving a location of a computing device from a location unit in the computing device and determine a number of a payment string based on the location; issuing a single-use payment card string based on the location of the computing device; uploading the single-use payment card string to a digital wallet application installed on the computing device, wherein the digital wallet application is configured to enable payment by transferring the payment card string to a payment terminal at a point of sale (POS) of a merchant, and the payment terminal is configured to request approval for a requested amount of money from the issuer server and to receive the requested amount of money after the approval from the issuer server; sending a request to remove the single-use payment card string from the digital wallet when a payment session ends; and deleting the single-use payment card string.

For example, the location unit comprises an at least one of Global Positioning System (GPS) receiver, Galileo receiver, Glonass receiver, BeiDou receiver, Quasi-Zenith Satellite System receiver (QZSS) and Indian Regional Navigation Satellite System (IRNSS) receiver.

For example, the location unit comprises location data, including a network ID, a Wi-Fi network location, a location provided by local cellular providers, and a location generated from a local transmitter beacon.

For example, the location of the computing device comprises a country or region.

For example, the location of the computing device comprises a state.

For example, the issuer server is configured to receive the longitude and latitude of the computing device and determine a number of the payment string based on the location.

For example, the computing device comprises a cellphone and the issuer server is configured to receive a cellphone identification and determine a number of the payment string based on the location of the cellphone.

For example, the payment card string comprises a payment card number according to a Europay, Mastercard, Visa (EMV) standard based on the location.

For example, the single-use payment card string is downloaded with the requested amount of money for paying at the POS.

For example, the single-use payment card string comprises a credit card number, a credit card date of issue and a credit card security code.

For example, the processing circuitry is configured to: detect an attempt of fraud by detecting usage of the single-use payment card out of a territory of usage of the single-use payment card.

It is understood from the present disclosure described a solution for shortcomings in the field of art. More specifically, the embodiments described herein enable the issuing of a single-use payment card string based on a user's location.

### BRIEF DESCRIPTION OF THE DRAWING

FIG. 1 illustrates a block diagram of a system for purchasing goods by a digital wallet application according to some demonstrative embodiments.

FIG. 2 illustrates a flow chart of a method for purchasing goods using a digital wallet application, according to some demonstrative embodiments.

FIG. 3 illustrates a product of manufacture according to some demonstrative embodiments.

FIG. 4 illustrates a block diagram of a part of the system of FIG. 1, which is adapted to issue a payment string based on a location, according to some demonstrative embodiments.

FIG. 5 illustrates a system for purchasing goods according to some other demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units, and/or circuits have not been described in detail so as not to obscure the discussion.

Discussions made herein utilizing terms such as, for example, “processing,” “computing,” “calculating,” “determining,” “establishing,” “analyzing,” “checking,” or the like, may refer to operation(s) and/or process(es) of a computer, a computing platform, a computing system, or other electronic computing devices, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality,” as used herein, include, for example, “multiple” or “two or more.” For example, “a plurality of items” includes two or more items.

References to “one embodiment,” “an embodiment,” “demonstrative embodiment,” “various embodiments,” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified, the use of the ordinal adjectives “first,” “second,” “third,” etc., to describe a common object merely indicate that different instances of like objects are being referred to and are not intended to imply that the objects so described must be in a given sequence, either temporally, spatially, in ranking, or any other manner.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some demonstrative embodiments, the circuitry may be implemented in, or functions associated with the circuitry may be implemented by one or more software or firmware modules. In some demonstrative embodiments, the circuitry may include logic, at least partially operable in hardware.

The term “logic” may refer, for example, to computing logic embedded in the circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in and/or implemented as part of various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read-only memory, programmable memory, magnetic memory, flash memory, persistent memory, and the like. Logic may be executed by one or more processors using memory, e.g., registers, stuck, buffers, and/or the like, coupled to one or more processors, e.g., as necessary to execute the logic.

The term “module,” as used hereinbelow, is an object file that contains code to extend the running kernel environment.

As used herein, the term “software engine” as used hereinbelow is an object file that contains code to extend the running kernel environment.

The term “digital wallet,” as used hereinbelow, is both a software and information component. Digital wallets may be stored on a client-side. The digital wallets may use a Near Field Communication (NFC), e.g., of smartphones, to transfer payments by touching the smartphone to a payment terminal at a store.

The term “loyalty club customer,” as used hereinbelow, is a business-to-business (B2B) customer who has a loyalty club offering and operates a loyalty-based mobile service, e.g., a loyalty card application for his customer base.

The term “Backend Platform,” as used hereinbelow, is a cloud platform, backend server, of the digital wallet system, which is configured to manage and control the digital wallet services and to interact with selected third-party systems, and with the digital wallet module and/or digital wallet engine and/or digital wallet software development kit (SDK).

The term “EMV,” as used hereinbelow, is a payment method based upon a technical standard for smart payment cards and for payment terminals, and automated teller machines. EMV originally stood for “Europay, Mastercard, and Visa,” the three companies which created the global payment standard.

The term “EMV terminal,” as used hereinbelow, is a payment terminal also known as a Point of Sale (POS) terminal, credit card terminal, etc. The EMV terminal is a device that interfaces with payment cards, e.g., Europay, Mastercard, Visa, to make electronic funds transfers. The terminal typically consists of a secure keypad for entering a PIN, a screen, a means of capturing information from payment cards, and a network connection to access the payment network for authorization.

In some demonstrative embodiments, the payment terminal may allow a merchant to capture required credit and/or debit card information and transmit this data to the merchant services provider and/or bank for authorization and transfer of funds to the merchant. The terminal may allow the merchant and/or their client to swipe, insert and/or hold a card near the device to capture the information.

The term “Issuer NFC-EMV SDK,” as used hereinbelow, may include, for example, an SDK issued and governed by the Issuers. For example, such SDK may be supported by a single Issuer, which allows for the communication of a payment card data string to an EMV terminal through an NFC protocol when integrated into a mobile application.

The term “digital wallet SDK for Mobile Devices,” as used hereinbelow, may include the digital wallet module and/or the digital wallet engine. The digital wallet SDK is the front-end of the digital wallet software program, which resides and is integrated within a custom mobile application. The digital wallet SDK may manage the front-end payment interaction of the end-user through the customer's mobile application. The digital wallet SDK may use an NFC protocol to communicate with an EMV Terminal of the vendor POS on behalf of the digital wallet platform either by communicating through the Issuer NFC-EMV SDK, which may be embedded within the Wallet SDK and/or directly. For example, the digital wallet SDK may be configured to interact with the digital wallet NFC-EMV SDK of a selected issuer, if desired.

The term “Server-Side SDK,” as used hereinbelow, is the front-end digital wallet software program. In some demonstrative embodiments, this program may reside and be integrated within a customer platform and may manage the front-end payment interaction of the end-user through the connection between the customer platform and the Customer mobile application. For example, the transaction may be managed by the customer platform against a vendor POS that the Customer Platform may be connected to.

The term “customer relationship manager (CRM) application programming interface (API),” as used hereinbelow, is an API configured to communicate with a customer CRM. The customer CRM is configured to manage one or more customer rewards programs.

The term “Credit Card Issuer” as used hereinbelow, may be a global company, e.g., a credit union that is configured to issue Credit Cards or payment cards or provide others, e.g., banks or other credit unions or other businesses, the right to issue Credit Cards and extend credit to their customers (“Issuer”).

The term “Credit Card Scheme,” as used hereinbelow, may include payment networks linked to credit cards and/or debit cards and/or prepaid cards or the like, e.g., payment cards, of which a bank and/or any other eligible financial institution and/or credit can be members. For example, members of the credit card scheme may issue cards and/or merchants operating on the network of that card scheme. The members can also set the various rules and limits of their schemes.

The term “Issuer Platform,” as used hereinbelow, may include, for example, the Mastercard, Visa, EuroPay, American Express, etc., servers, which may be configured to allow for the issuing of cards.

The term “Card(s)” as used hereinbelow, may include, for example, the prepaid card created and issued by an issuer, credit cards, debit cards, or the like.

The term “Merchant POS,” as used hereinbelow, may include, for example, the credit card terminal of a specific merchant and/or vendor and/or shop and/or etc., on which various payment transactions can be made when an End-User decides to consume a payment transaction using his Customer Mobile application.

The term “Customer Platform,” as used hereinbelow, may include, for example, the technology platform of a customer of a partner which is configured to engage with the digital wallet for the provision of payments through the digital wallet platform. The backend technology platform communicates with the Customer Mobile Application as well as with the digital wallet SDK, depending on the payment configuration chosen by the customer and/or partner. For example, this platform will be cloud-based, running on, for example, Amazon Web Services (AWS) and/or Microsoft AZURE.

The term “Customer Credit Card Terminal,” as used hereinbelow, may include a transaction terminal, EMV and/or non-EMV, which may be used by the Customer platform to generate a token for each End-User credit card associated with the mobile customer application. For example, such terminals may reside with a payments gateway company or processor company

The term “customer mobile application,” as used hereinbelow, may include at least one application which is installed on the customer's mobile device, for example, the loyalty club application, e-Wallet application, or the like. The mobile customer application may include the digital wallet SDK and may interact with the digital wallet platform and the customer platform. The mobile customer application may be configured to run on a mobile device operating system, such as, for example, iOS and Android or React.

The term “customer CRM,” as used hereinbelow, may include, for example, the loyalty club platform that the customer uses to manage his customers base and his reward schemes and other programs across various segments and plans.

The term “digital wallet rules engine,” as used hereinbelow, may include, for example, an admin system where the customer can define various rules, including Merchant Category Code (MCC), wherein the MCC includes universal codes on the card scheme that define the various purchase/merchants categories, such as, for example, clothing, sports shoes, etc. codes, and limitations, etc., for transactions made by the end-users.

The term “End-User” as used hereinbelow, may include one or more users who use the mobile customer application.

The term “payment string,” as used hereinbelow, is configured to include encrypted information of a payment ability of the user, for example, a credit card, a debit card, bank money transfer information, or the like. For example, if a card number is 1234 5678 8765 4321, the token identification may be, for example, E67TL8GC27X. In some demonstrative embodiment, the payment string may be configured to access, retrieve, and maintain, for example, a customer's credit card information to ensure a higher level of security for both the customer and the business. The payment string may be saved on the customer platform and/or on the customer's mobile application. In some demonstrative embodiments, the payment string may include a single-use payment card. The payment string may also be referred to as a token.

The term “Token Service Provider (TSP),” as used hereinbelow, is an entity certified by, for example, MasterCard, Visa, or any other issuers, which are allowed to generate EMV tokens. The TSP may include an entity within the payments ecosystem that is configured to provide registered token requestors. For example, the merchants holding the card credentials—with ‘surrogate’ Primary Account Number (PAN) values, otherwise known as payment tokens. For example, the service may be provided by gateway services if desired.

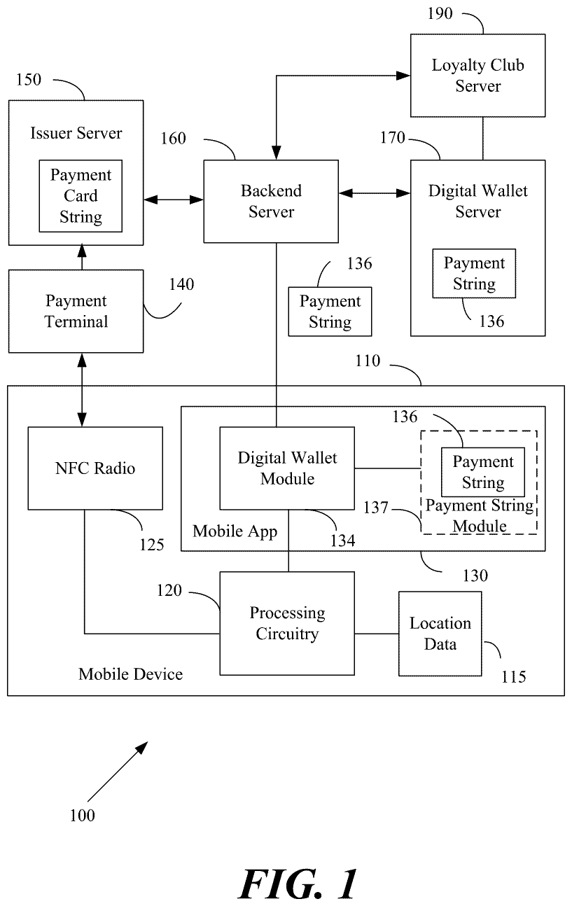

Reference is made first to FIG. 1, which is an illustration of a block diagram of a system for payments 100 with a digital wallet application 130 according to some demonstrative embodiments.

In some demonstrative embodiments, system 100 may include a mobile device 110. For example, mobile device 110 may include at least one of a smartphone, a tablet, a mobile computer, an electronic wallet, or the like.

In some demonstrative embodiments, mobile device 110 may include processing circuitry 120. For example, processing circuitry 130 may include one or more processors having one or more cores, a digital signal processor, a graphic processor, a communication processor, one or more memories, and the like.

In some demonstrative embodiments, mobile device 110 may include a near field communication (NFC) radio 125 configured to perform a payment controlled by a digital wallet module 134. For example, the payment may be made by attaching the mobile device 110 to a payment terminal 140 at a point of sale (POS), e.g., a store, a restaurant, a service provider, etc.

In other demonstrative embodiments, it should be understood that the digital wallet module 134 may configure to control other methods of payments performed by the mobile application 130, e.g., payment application, digital wallet application, loyalty club application, and the like.

In some demonstrative embodiments, before the user performs a payment, processing circuitry 120 may be configured to upload a one-time use virtual payment card with zero amount of money, e.g., a token 136 including a single-use payment card, to the digital wallet 130 to enable the purchase and/or payment. For example, the token, e.g., a payment card, may include a credit card number, e.g., a one-time-use credit card number, a credit card date of issue, and a credit card security code.

For example, the digital wallet application 130 may include a digital wallet module 134, and the digital wallet module may include an EMV SDK (not shown) to store the token 136, e.g., a single-use payment card.

In some demonstrative embodiments, token 136 may include a user loyalty club creditability information, e.g., a currency value of the user loyalty club point.

In some demonstrative embodiments, token 136, e.g., single-use payment card, is encrypted, and the digital wallet module 134 is configured to decrypt the content of token 136, e.g., single-use payment card.

In some demonstrative embodiment, the token 136, e.g., single-use payment card, may be provided with a one-time use identification code. For example, token 136, a single-use payment card, may be used only once for only one purchase and/or payment.

In some demonstrative embodiments, the user may perform the payment for the purchase, for example, by touching mobile device 110 to the payment terminal 140. For example, payment terminal 140 may send a request to the issuer server 150 for approval of an amount of payment, e.g., a required amount of payment.

In some demonstrative embodiments, the issuer server 150 may approve or deny the payment and may send the payment information to the backend server 160.

In some demonstrative embodiments, processing circuitry 120, e.g., through the digital wallet application 130, may receive approval indication for the payment from backend server 160. If the payment terminal 140 received approval from issuer server 150. For example, the approval may include the requested amount of money for payment. The payment terminal 140 may transfer the amount of money to a merchant.

In some demonstrative embodiments, after the payment, the issuer server 150 may delete token 136, e.g., single-use payment card, and the processing circuitry 120 may instruct the digital wallet module 134 to remove token 136, e.g., single-use payment card. The issuer server 150 may issue a new token with a zero amount of money and user data to be used on the next purchase, wherein the new token, e.g., a single-use payment card, may include a different identification code than the first token, e.g., a single-use payment card.

In some demonstrative embodiments, issuer server 150 may issue a local single-use payment card, e.g., a token, based on the location of the mobile device 110. For example, mobile device 110 may send location data 115 to the issuer server 150.

For example, the location data 115 may include a location based on the network ID, a location based on the Wi-Fi network location, a location based on a list of local cellular service providers, a location based on a network beacon, a location based on GPS, and the like.

It should be understood that the issuer server 150 does not necessarily need the exact location to issue a local payment card. A location that includes only the country and/or the state may be sufficient. In some other embodiment, a location of a city and/or an area may be used.

In some demonstrative embodiments, the processing circuitry 120 may be configured to upload the new token, e.g., a single-use payment card, with a zero balance, to the digital wallet application 130, e.g., digital wallet module 134, to be used in the next purchase.

In some demonstrative embodiments, the digital wallet module 134 may be configured to provide a payment ability to one or more applications installed on the mobile device by installing the digital wallet module 134 to one or more applications installed on the mobile device.

For example, the user digital wallet module 134 may be operably engaged to a user loyalty club application and may be configured to transform one or more loyalty card credits into a currency and to enable a digital transfer of payment, for example, for goods at a store and/or services, and/or any payment that can be done with a payment card.

In some demonstrative embodiments, a loyalty club server 190 may send the end-user data and the loyalty club rules to a digital wallet server 170. The digital wallet server 170 may convert the loyalty club points into currency based on the rules and may transfer the balance to the digital wallet module 134 to purchase, for example, goods at stores, such as, for example, stores with agreements with the loyalty club and/or any other stores.

Advantageously, using the single-use payment card having, for example, a zero amount of money may enable a secured and safe use of a digital wallet because the single-use payment card can be used only once and can be blocked and/or deleted remotely when the mobile device is breached and/or hacked. In addition, the single-use payment card system may optimize the response time of money transactions because of the use of the single-use payment card having, for example, a zero amount of money and preinstalled on the digital wallet.

Another advance of the single-use payment card system may optimize the monitory management of the single-use payment card by managing the user account at the server and by paying the exact amount of money requested at the POS.

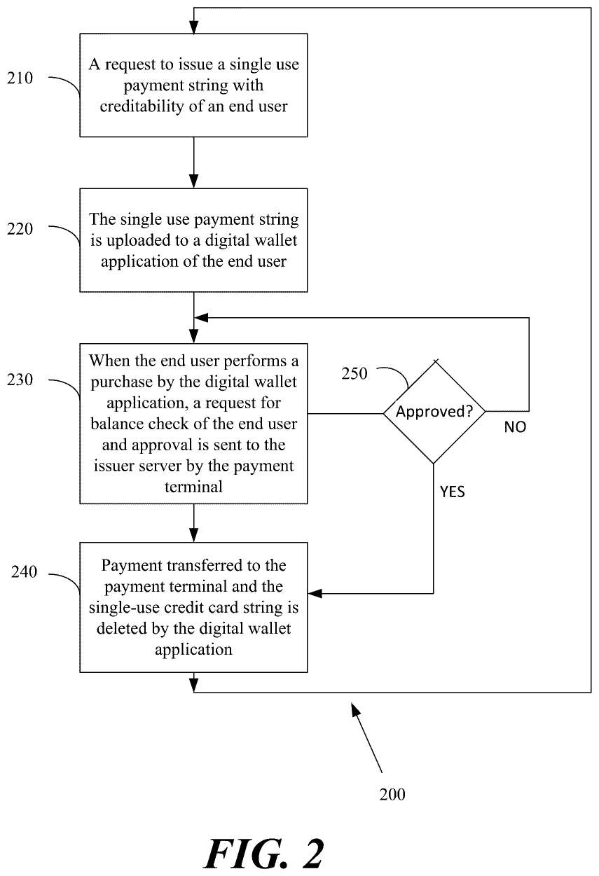

Reference is now made to FIG. 2, which is a schematic illustration of a flow chart of a method for purchasing goods using a digital wallet application, according to some demonstrative embodiments.

In some demonstrative embodiments, method 200 may start with a request to issue a one-time use a single-use payment card data having, for example, a zero amount of money, e.g., token 136 (FIG. 1) with the creditability of an end-user, from the digital wallet application, e.g., the digital wallet application 130 (text box 210).

For example, the request may be sent to an issuer server, e.g., issuer server 150 (FIG. 1), through the backend server 160, if desired.

In some demonstrative embodiments, the issuer server 150 may issue a single-use virtual credit card and/or debit card and/or any other data related to the end-user creditability. It should be understood that the single-use virtual payment card may be issued without any balance, for example, a zero balance.

For example, the single-use virtual payment card may include a least one of a credit card, a debit card, a charge card, a prepaid card, or the like.

In some demonstrative embodiments, the backend server, e.g., backend server 160 (FIG. 1), may generate the single-use virtual payment card, e.g., token 136 (FIG. 1), e.g., single-use payment card.

In some demonstrative embodiments, the token, e.g., a single-use payment card, may be uploaded to the digital wallet application, e.g., the digital wallet application 130 (FIG. 1) (text box 220).

In some demonstrative embodiment, when the end-user performs a purchase by the digital wallet application, a request for a balance check of the end-user and approval of the payment may be sent to the issuer server, for example, by the payment terminal, e.g., payment terminal 140 (FIG. 1) (text box 230).

For example, the issuer server 150 (FIG. 1) may receive a call from the payment terminal 140 (FIG. 1) to check the bank account balance of a buyer, e.g., the end-user. The issuer server may approve or deny the request for payment. If the issuer server approves the payment, the issuer server may upload the amount of payment to the payment card.

In some demonstrative embodiments, if the approval for the payment has been received at the payment terminal (text box 250), the payment terminal may collect the payment, and the issuer server may, for example, block the virtual payment card, and the digital wallet module may delete the token, e.g., single-use payment card, (text box 240).

In some demonstrative embodiment, method 200 may restart with a second virtual payment card and a second token, e.g., a second single-use payment card.

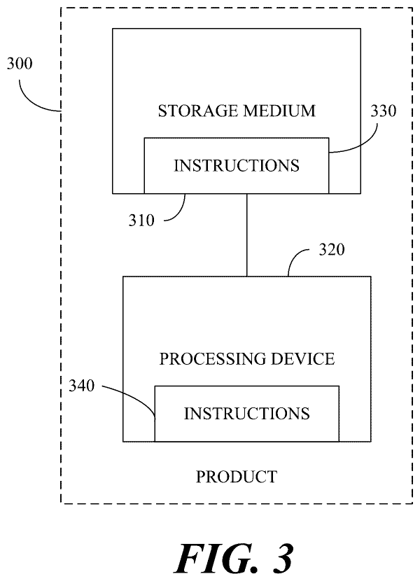

Reference is now made to FIG. 3, which is a schematic illustration of a product of manufacture 300, according to some demonstrative embodiments. Product 300 may include one or more tangible computer-readable non-transitory storage media 310, which may include computer-executable instructions 330, implemented by processing device 320, operable to, when executed by at least one computer processor, enable the at least one processing circuitry 120 (FIG. 1) to implement one or more program instructions for purchasing goods with a digital wallet application and/or to perform, trigger and/or implement one or more operations, communications and/or functionalities as described above with reference to FIGS. 1 and 2. The phrase “non-transitory machine-readable medium” is directed to include all computer-readable media, with the sole exception being a transitory propagating signal.

In some demonstrative embodiments, product 300 and/or machine-readable storage medium 310 may include one or more types of computer-readable storage media capable of storing data, including volatile memory, non-volatile memory, removable or non-removable memory, erasable or non-erasable memory, writeable or re-writeable memory, and the like. For example, machine-readable storage medium 310 may include any type of memory, such as, for example, RAM, DRAM, ROM, programmable ROM (PROM), erasable programmable ROM (EPROM), electrically erasable programmable ROM (EEPROM), Flash memory, a hard disk drive (HDD), a solid-state disk drive (SDD), fusen drive, and the like. The computer-readable storage media may include any suitable media involved with downloading or transferring a computer program from a remote computer to a requesting computer carried by data signals embodied in a carrier wave or other propagation medium through a communication link, e.g., a modem, radio, or network connection.

In some demonstrative embodiments, processing device 320 may include logic. The logic may include instructions, data, and/or code, which, if executed by a machine, may cause the machine to perform a method, process, and/or operations as described herein. The machine may include, for example, any suitable processing platform, computing platform, computing device, processing device, a computing system, processing system, computer, processor, or the like, and may be implemented using any suitable combination of hardware, software, firmware, and the like.

In some demonstrative embodiments, processing device 320 may include or may be implemented as software, firmware, a software module, an application, a program, a subroutine, instructions, an instruction set, computing code, words, values, symbols, and the like. Instructions 340 may include any suitable types of code, such as source code, compiled code, interpreted code, executable code, static code, dynamic code, and the like. Instructions may be implemented according to a predefined computer language, manner, or syntax, for instructing a processor to perform a specific function. The instructions may be implemented using any suitable high-level, low-level, object-oriented, visual, compiled, and/or interpreted programming languages, such as C, C++, C#, Java, Python, BASIC, Mat lab, assembly language, machine code, and the like.

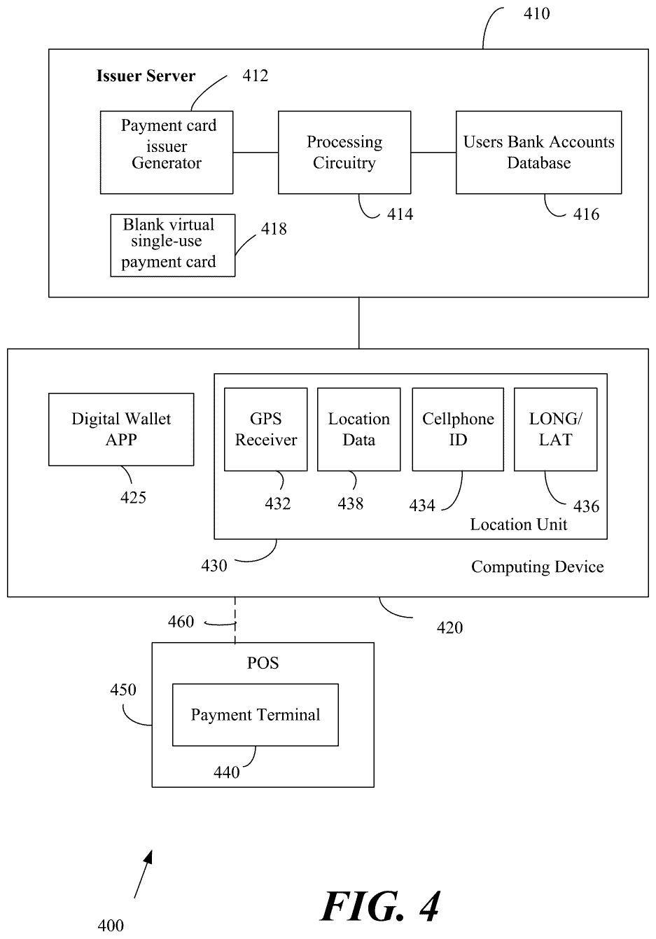

Reference is now made to FIG. 4, which is an illustration of a block diagram 400 of a part of the system 100 of FIG. 1, which may be adapted to issue a payment string based on a location, according to some demonstrative embodiments.

In some demonstrative embodiments, system 400 may include an issuer server 410. The issuer server 410 may include at least, but is not limited to, a payment string generator 412, processing circuitry 414, and users' bank accounts database 416.

In some demonstrative embodiments, payment generator 412 may be configured to issue a payment card string 418, for example, a single-use payment card string. For example, single-use payment card string 418 may be an EMV payment card string. However, in other embodiments, it may be generated in any other desired format.

In some demonstrative embodiments, system 400 may be configured to make payments with a digital wallet application 425. The digital wallet application may be installed in a computing device 420. For example, computing device 420 may include a cellular phone, a laptop computer, a desktop computer, a mobile device, and/or any other computing device.

In some demonstrative embodiments, system 400 may include a POS 450. The POS may include a payment terminal 440.

In some demonstrative embodiments, processing circuitry 414 of issuer server 410 may be configured to: issue a single-use payment card string 418 based on a location of a computing device 420, download the single-use payment card string 418 to digital wallet application 425 installed on computing device 420, wherein the digital wallet application 425 may be configured to enable payment by transferring the single-use payment card string 425 to a payment terminal 440 at a point of sale (POS) 450 of a merchant using a radio (dotted line 460), and the payment terminal 440 may be configured to request approval for a requested amount of money from the issuer server 410 and to receive the requested amount of money after the approval from the issuer server 440.

In some demonstrative embodiments, the processing circuitry 414 may be configured to send a request to remove the single-use payment card string from digital wallet 425 when a payment session ends and delete the single-use payment card string 418.

In some demonstrative embodiments, issuer server 410 may be configured to receive the location from a location receiver unit 430 at the computing device 420 and may determine a unique number of the payment card string 418 based on the location.

In some demonstrative embodiments, the location unit receiver 430 may include an at least one of Global Positioning System (GPS) receiver 432, Galileo receiver, Glonass receiver, BeiDou receiver, Quasi-Zenith Satellite System receiver (QZSS), and Indian Regional Navigation Satellite System (IRNSS) receiver.

For example, the issuer server 410 may be configured to receive a location from GPS system 432 and may determine a card number of the payment card string 418 based on the location provided by GPS system 432.

In some demonstrative embodiments, the issuer server 410 may be configured to receive the longitude and latitude 436 from the location receiver of the computing device 420 and determine a card number of the payment card string 418 based on the location provided by the received longitude and latitude 436.

In some other demonstrative embodiments, the computing device 420 may include a cellphone, and the issuer server 410 may be configured to receive the cellphone ID 432 and may determine a card number of the payment card string based on the location provided by cellphone ID 432.

In some demonstrative embodiments, the issuer server 410 be configured to receive location data 438 from the location unit 430 of the computing device 420 and may determine a card number of the payment card string 418 based on the location provided by the location data 438.

In some demonstrative embodiments, the location data 438 may include, for example, a network ID, a Wi-Fi network location, a location of local cellular providers, a location generated from a local transmitter beacon and/or any other source that can provide location data.

It should be understood that the issuer server 412 does not need an exact location of computing device 420 to issue a local payment card. A location that includes only the country and/or the state may be sufficient. In some other embodiment, a location of a city and/or an area may be used.

In some demonstrative embodiments, wherein the payment string comprises a payment card number according to a Europay, Mastercard, Visa (EMV) standard based on the location.

In some demonstrative embodiments, the single-use payment string 418 may be downloaded with the requested amount of money for paying at the POS.

In some demonstrative embodiments, the single-use payment card string 416 may include an at least one of: a credit card number, a credit card date of issue, and a credit card security code

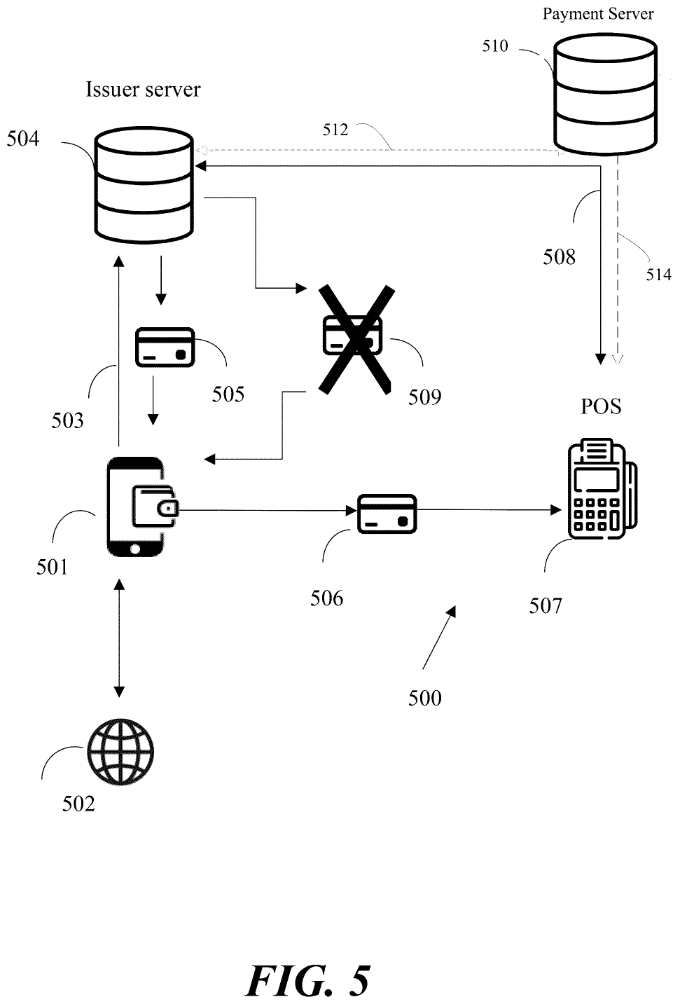

Reference is now made to FIG. 5, which is an illustration of a system for purchasing goods according to some other demonstrative embodiments.

In some demonstrative embodiments, system 500 may include a cellular device comprising a payment card wallet 501, location data 502, and a server 504, issued according to a location payment card 505 and a POS 507.

In operation, cellular device 501 may receive a location from location data 502. Cellular device 501 may request server 504 to issue a payment card based on the location of the cellular device 503 and/or location data 402. Server 504 may consider request 503 and may issue a payment card 505 based on the location of the cellular device 501.

In some demonstrative embodiments, the location data 502 may include, for example, a network ID, a Wi-Fi network location, a location of local cellular providers, a location generated from a local transmitter beacon and/or any other source that can provide location data.

It should be understood that the issuer server 502 does not need an exact location of cellular device 501 to issue a local payment card. A location that includes only the country and/or the state may be sufficient. In some other embodiment, a location of a city and/or an area may be used.

In some demonstrative embodiments, a user of the cellular device 501 may purchase goods and/or services from a merchant in the POS 507. The POS may send a request to approve the purchase 508 to server 504. Server 504 may approve or deny the purchase and/or the payment. If the payment has been approved, the server may delete the payment card 505.

In some other demonstrative embodiments, server 504 may delete the payment card if the payment is denied.

In some demonstrative embodiments, the local payment card 505 may be used for fraud detection. For example, if system 500 may identify the use of payment card 505 in another location out of the territory of payment card 505. The system may ask the cardholder to approve the purchase, or the system can automatically block the use of payment card 505 out of his territory.

It is to be understood that the system and/or the method for purchasing goods is described hereinabove by way of example only. Other embodiments may be implemented based on the detailed description and the claims that followed.

It is to be understood that like numerals in the drawings represent like elements through the several figures and that not all components and/or steps described and illustrated with reference to the figures are required for all embodiments or arrangements.

It should also be understood that the embodiments, implementations, and/or arrangements of the systems and methods disclosed herein can be incorporated as a software algorithm, application, program, module, or code residing in hardware, firmware, and/or on a computer useable medium (including software modules and browser plug-ins) that can be executed in a processor of a computer system or a computing device to configure the processor and/or other elements to perform the functions and/or operations described herein.

It should be appreciated that according to at least one embodiment, one or more computer programs, modules, and/or applications that, when executed, perform methods of the present invention need not reside on a single computer or processor but can be distributed in a modular fashion amongst a number of different computers or processors to implement various aspects of the systems and methods disclosed herein.

Thus, illustrative embodiments and arrangements of the present systems and methods provide a computer-implemented method, computer system, and computer program product for processing code(s). The flowchart and block diagrams in the figures illustrate the architecture, functionality, and operation of possible implementations of systems, methods, and computer program products according to various embodiments and arrangements. In this regard, each block in the flowchart or block diagrams can represent a module, segment, or portion of code, which comprises one or more executable instructions for implementing the specified logical function(s).

It should also be noted that, in some alternative implementations, the functions noted in the block can occur out of order noted in the figures. For example, two blocks shown in succession may be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by particular purpose hardware-based systems that perform the specified functions or acts, or combinations of specialized purpose hardware and computer instructions.

The terminology used herein is to describe particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof.

Also, the phraseology and terminology used herein is for the purpose of description and should not be regarded as limiting. The use of “including,” “comprising,” or “having,” “containing,” “involving,” and variations thereof herein is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described and without departing from the true spirit and scope of the present invention, which is set forth in the following claims.

1.-51. (canceled)

52. A system for making payments with a digital wallet application comprising:
a computing device;
an issuer server comprises a processing circuitry, wherein the processing circuitry is configured to:
receive a location of the computing device from a location unit in the computing device and determine a number of a payment string based on the location;
issue a single-use payment card string based on the location of the computing device;
upload the single-use payment card string to a digital wallet application installed on the computing device, wherein the digital wallet application is configured to enable payment by transferring the payment string to a payment terminal at a point of sale (POS) of a merchant and the payment terminal is configured to request approval for a requested amount of money from the issuer server and to receive the requested amount of money after the approval from the issuer server;
send a request to remove the single-use payment card string from the digital wallet when a payment session ends; and
delete the single-use payment card string.

53. The system of claim 52, wherein the location unit comprises an at least one of Global Positioning System (GPS) receiver, Galileo receiver, Glonass receiver, BeiDou receiver, Quasi-Zenith Satellite System receiver (QZSS) and Indian Regional Navigation Satellite System (IRNSS) receiver.

54. The system of claim 52, wherein the location unit comprises location data, including a network ID, a Wi-Fi network location, a location of local cellular providers, and a location generated from a local transmitter beacon.

55. The system of claim 52, wherein the location of the computing device comprises a country.

56. The system of claim 52, wherein the location of the computing device comprises a state.

57. The system of claim 52, wherein the issuer server is configured to receive the longitude and latitude of the mobile device and determine a number of the payment string based on the location.

58. The system of claim 52, wherein the issuer server is configured to receive the longitude and latitude of the mobile device and determine a number of the payment string based on the location.

59. The system of claim 52, wherein the payment string comprises a payment card number according to a Europay, Mastercard, Visa (EMV) standard based on the location.

60. The system of claim 52, wherein the single-use payment card string is downloaded with the requested amount of money for paying at the POS.

61. The system of claim 52, wherein the single-use payment card string comprises a credit card number, a credit card date of issue and a credit card security code.

62. The system of claim 52, wherein the single-use payment card string comprises a zero amount of money and user data.

63. The system of claim 52, wherein the processing circuitry is configured to transfer the payment card string to the payment terminal by using a near field communication (NFC).

64. The system of claim 52, wherein the processing circuitry is configured to:
detect an attempt of fraud by detecting usage of the single-use payment card out of a territory of usage of the single-use payment card.

65. A product comprising one or more tangible computer-readable non-transitory storage media comprising program instructions for making payments with a digital wallet application, wherein execution of the program instructions by one or more processors of an issuer server comprising:
receiving a location from a location unit at a computing device and determine a number of a payment string based on the location;
issuing a single-use payment card string based on the location of the computing device;
uploading the single-use payment card string to a digital wallet application installed on the computing device, wherein the digital wallet application is configured to enable payment by transferring the payment card string to a payment terminal at a point of sale (POS) of a merchant, and the payment terminal is configured to request approval for a requested amount of money from the issuer server and to receive the requested amount of money after the approval from the issuer server;
sending a request to remove the single-use payment card string from the digital wallet when a payment session ends; and
deleting the single-use payment card string.

66. The product of claim 65, wherein the location unit comprises an at least one of Global Positioning System (GPS) receiver, Galileo receiver, Glonass receiver, BeiDou receiver, Quasi-Zenith Satellite System receiver (QZSS) and Indian Regional Navigation Satellite System (IRNSS) receiver.

67. The product of claim 65, wherein the issuer server is configured to receive the longitude and latitude of the computing device and determine a number of the payment string based on the location.

68. The product of claim 65, wherein the computing device comprises a cellphone and the issuer server is configured to receive a cellphone identification and determine a number of the payment string based on the location of the cellphone.

69. The product of claim 65, wherein the location unit comprises location data, including a network ID, a Wi-Fi network location, a location of local cellular providers, and a location generated from a local transmitter beacon.

70. The product of claim 65, wherein the location of the computing device comprises a country.

71. The product of claim 65, wherein the location of the computing device comprises a state.

72. The product of claim 65, wherein the payment card string comprises a payment card number according to a Europay, Mastercard, Visa (EMV) standard based on the location.

73. The product of claim 65, wherein the single-use payment card string is downloaded with the requested amount of money for paying at the POS.

74. The product of claim 65 wherein the single-use payment card string comprises a credit card number, a credit card date of issue and a credit card security code.

75. The product of claim 65, wherein execution of the program instructions by one or more processors of an issuer server comprising:
detecting an attempt of fraud by detecting usage of the single-use payment card out of a territory of usage of the single-use payment card.
